(19) United States
(12) Patent Application Publication
(10) Pub. No.: US 2007/0004414 A1
(43) Pub. Date: Jan. 4, 2007

(54) Mobile terminal device and motion control method thereof

(75) Inventors: Toshinori Seki, Kanagawa (JP); Masashi Horita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/471,663

(22) Filed: Jun. 21, 2006

(30) Foreign Application Priority Data
Jun. 29, 2005 (JP) 2005-190229

(51) Int. Cl. H04Q 7/20

(52) U.S. Cl. 455/441

(57) ABSTRACT

A mobile terminal device includes a threshold storing unit for retaining a threshold of field intensity, a comparator for comparing field intensity of a signal received from a base station with the threshold and outputting an electric field existence signal, a demodulation circuit for starting a reception operation according to a specified transition of the electric field existence signal, and a threshold setting unit for changing a threshold retained by the threshold storing unit according to a specified transition of the electric field existence signal.

### BACKGROUND OF THE INVENTION

1. Field of the Invention

The present invention relates to a mobile terminal device and a motion control method for detecting data transmitted from a base station to detect a base station with a mobile terminal device.

2. Description of the Related Art

A mobile terminal device such as a cellular phone and a PHS (Personal Handyphone System) receives radio signals from a plurality of base stations. A mobile terminal measures field intensity of a received signal and sends a request for establishing a link to a base station having stronger field intensity.

Hence base stations transmit data called a control slot at a regular interval. A technique that measures field intensity of a slot and a mobile terminal starts receiving based on a result of the measurement is disclosed in Japanese Unexamined Patent Application Publication No. 11-186927.

However if timings of transmitting the control slots between the base stations are not synchronized, a mobile terminal sometimes redundantly receives a plurality of the control slots to cause a reception error. FIGS. 9A to 9C are a view showing an operation when such an error is generated. FIG. 9C shows a control slot transmitted from a first base station, and FIG. 9B shows a control slot transmitted from a second base station. Suppose that the second base station is located closer to a mobile terminal than a first base station. FIG. 9A shows field intensity of a signal that a mobile terminal receives. At a time t81 shown in FIGS. 9A to 9C, field intensity that the mobile terminal receives rises and the mobile terminal starts receiving control slots from a first base station. At a time t82 in FIGS. 9A to 9C, if the second base station starts transmitting control slots while the mobile terminal is still receiving control slots from the first base station, the mobile terminal then receives control slots from the second base station because field intensity of the signals received from the second base station is stronger. A conventional mobile terminal does not recognize that base station transmitting control signals has changed. The mobile terminal is therefore unable to properly receive control slots from neither of the first and the second base stations, leading to a reception error.

As described in the foregoing, the present invention has recognized that with a conventional mobile terminal, if base stations are not synchronized, a reception error is generated to cause a drop in reception quality.

### SUMMARY OF THE INVENTION

According to an aspect of the present invention, there is provided a mobile terminal device that includes a threshold storing unit for retaining a threshold of field intensity, a comparator for comparing field intensity of a signal received from a base station with the threshold and outputting an electrical field existence signal, a demodulation circuit for starting a reception operation based on a specified transition of the electrical field existence signal, and a threshold setting unit for changing the threshold retained by the threshold storing unit based on a specified transition of the electrical field existence signal.

According to another aspect of the present invention, there is provided a motion control method for a mobile terminal device that compares field intensity of a signal received from a base station with a threshold, starts a reception operation based on a result of the comparison, and changes the threshold based on field intensity of a signal received from the base station during the reception operation.

The configuration described above enables to reduce reception error in a mobile terminal.

### BRIEF DESCRIPTION OF THE DRAWINGS

The above and other objects, advantages and features of the present invention will be more apparent from the following description taken in conjunction with the accompanying drawings, in which:

FIG. 1 is a relation diagram of a communication system according to embodiments of the present invention;

FIG. 2 is a view showing a configuration of a mobile terminal according to a first embodiment of the present invention;

FIG. 3 is a timing chart showing an operation according to the first embodiment of the present invention;

FIGS. 4A to 4D are a timing chart showing an operation according to the first embodiment of the present invention;

FIG. 5 is a flow chart showing an operation according to the first embodiment of the present invention;

FIG. 6 is a view showing a configuration of a mobile terminal according to a second embodiment of the present invention;

FIG. 7 is a schematic view showing a configuration of a control slot;

FIG. 8 is a flow chart showing an operation according to the second embodiment of the present invention; and

FIGS. 9A to 9C are a timing chart showing an operation of a mobile terminal according to a conventional technique.

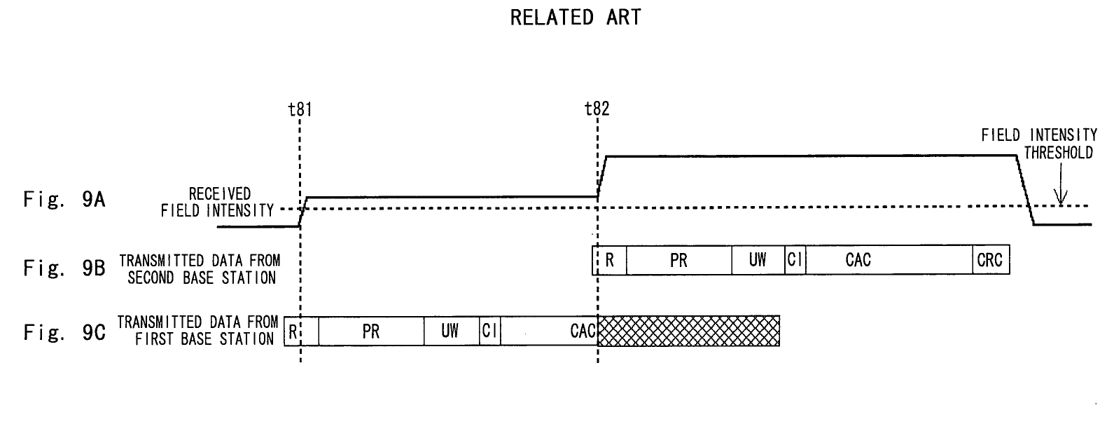

### PREFERRED EMBODIMENT OF THE INVENTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

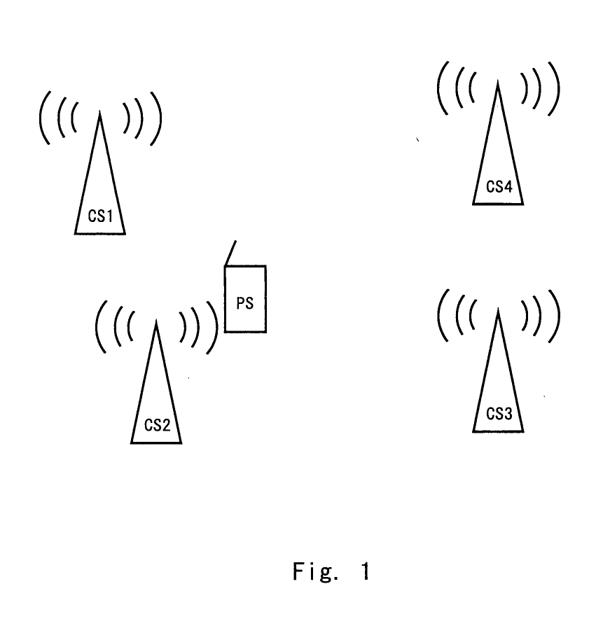

An example of applying the present invention to a communication system using PHS is described in embodiments. FIG. 1 is a view showing a relation between a mobile terminal and base stations that the present invention is applied thereto. In the embodiments, a first to a fourth base stations CS1 to CS4 as shown in FIG. 1 are located. A mobile terminal PS is located to where it is closest to the second base station CS2. Respective base stations transmit control slots at specified time intervals. The mobile terminal PS measures field intensity of the control slots to select a base station to establish a link therewith.

### First Embodiment

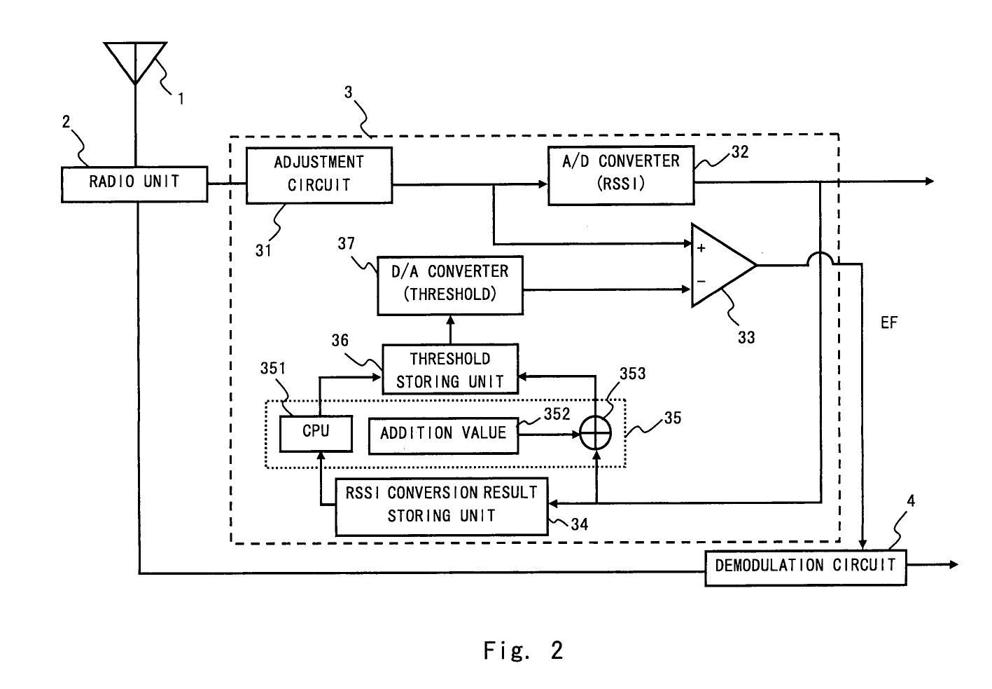

FIG. 2 is an outline block diagram of a mobile terminal PS according to a first embodiment of the present invention. As shown in FIG. 2, the mobile terminal PS includes an antenna 1, a radio unit 2, a field intensity (RSSI) evaluation unit 3, and a demodulation circuit 4.

The antenna 1 transmits/receives radio waves for radio communication between the base stations. The radio unit 2 performs filtering and frequency conversion for a signal received by the antenna, and outputs a baseband signal. The RSSI evaluation unit 3 measures field intensity of the received signal and outputs a field existence signal EF, which is to be a reference for evaluating whether there is any communicable base station. The demodulation circuit 4 is a circuit for demodulating received data from a baseband signal. The demodulation circuit 4 operates according to the electric field existence signal EF. If the electric field existence signal EF becomes a signal indicating “electric field exists”, the demodulation circuit starts a demodulation operation and keeps demodulating until completing to receive control slot data. With the configuration explained in the foregoing, demodulation of received data is performed according to a RSSI of radio wave that a mobile terminal of this embodiment receives. A data process circuit for processing demodulated data (not shown) is connected subsequent to the demodulation circuit. In the first embodiment, the data process circuit also operates according to the electric field existence signal EF.

The RSSI evaluation unit 3 of the first embodiment includes an adjustment circuit 31, an A/D converter 32, a RSSI comparator 33, a RSSI conversion result storing unit 34, a threshold setting unit 35, a threshold storing unit 36, and a D/A converter 37.

The adjustment circuit 32 is a circuit for adjusting an analog voltage level of RSSI. The A/D converter 32 converts a RSSI level being adjusted by the adjustment circuit 32 into a digital signal and outputs the digital signal as a RSSI digital value. The threshold storing unit 36 retains a threshold of RSSI in order for the RSSI evaluation unit 3 to evaluate that “electric field exists”. Assume that the threshold storing unit 36 retains the threshold as a digital signal. The D/A converter 37 converts the threshold retained in the threshold storing unit 36 into an analog signal to output it.

The RSSI comparator 33 is a circuit for comparing field intensity for RSSI outputted by the adjustment circuit 32 with an analog signal corresponding to the threshold outputted by the D/A converter. The RSSI comparator 33 outputs an electric field existence signal EF indicating “electric field exists” if field intensity for RSSI is more than or equal to the threshold, whereas if field intensity for RSSI is less than or equal to the threshold, the RSSI comparator 33 outputs the electric field existence signal EF indicating “electric field does not exist”. The RSSI conversion result storing unit is a register for retaining a RSSI digital value that is converted into a digital signal by the A/D converter 32.

In the first embodiment, the threshold setting unit 35 specifies a threshold that is retained by the threshold storing unit 36. The threshold setting unit 35 of the first embodiment includes an addition value storing unit 352, an adder 353, and a control unit 351. The control unit 351 is for example CPU to perform addition operation and motion control in order for the threshold storing unit 36 to retain a threshold. The added value storing unit 352 is a unit for example to retain a specified value. The specified value is an addition value, which is described later, and the value is appropriately specified depending on a specification of a mobile terminal. The adder 353 adds the specified value retained in the added value storing unit 32 to the RSSI digital value and output the added value to the threshold storing unit 36.

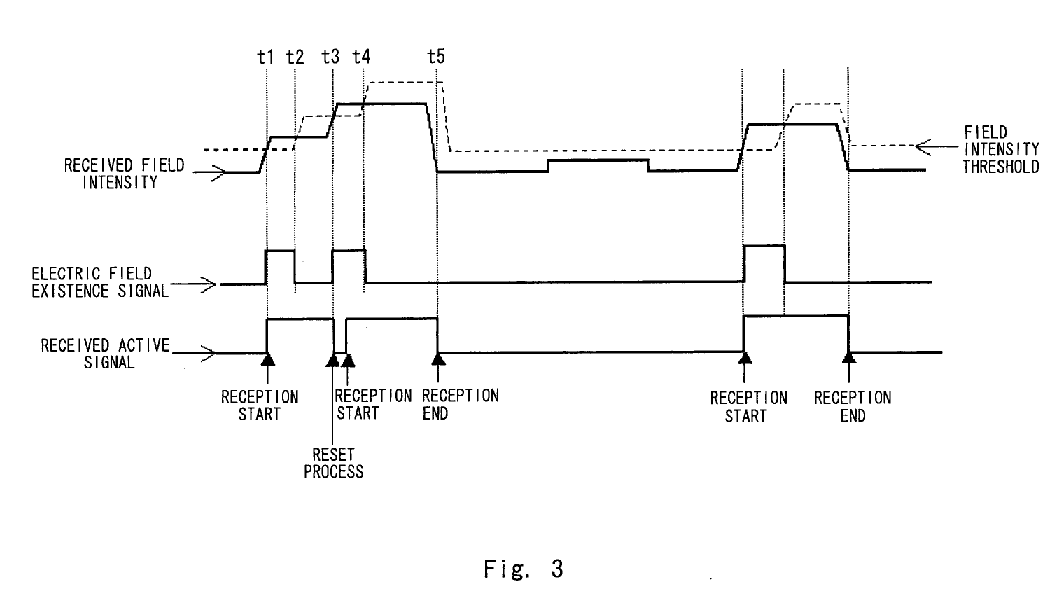

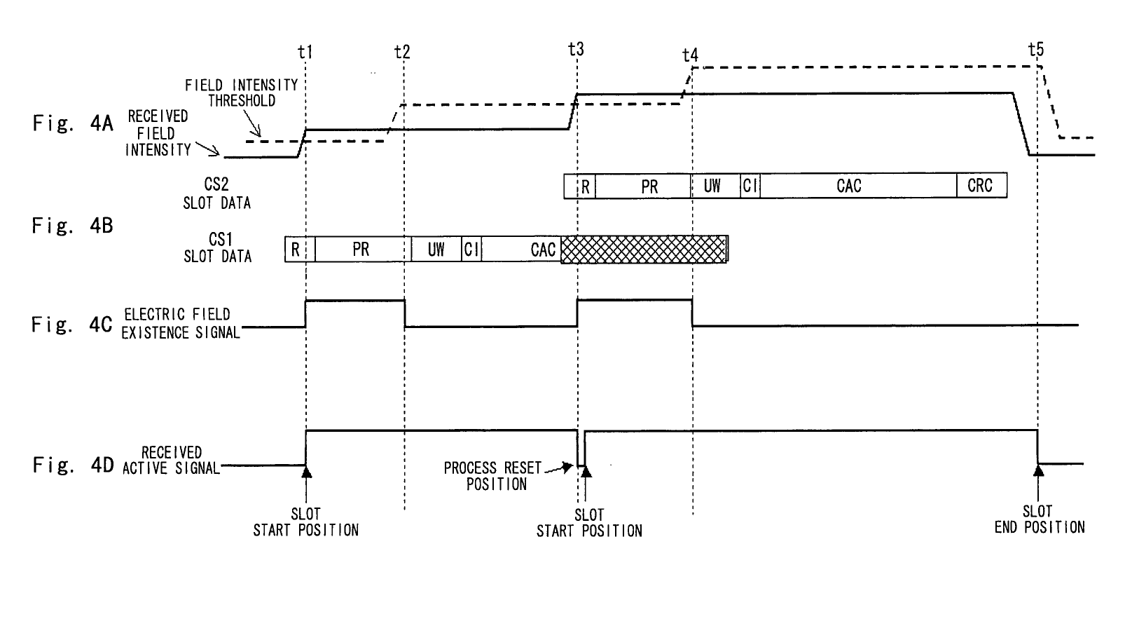

An operation of a mobile terminal of this embodiment configured as above is described in detail hereinafter. FIG. 3 is a timing chart explaining an operation of the mobile terminal of the first embodiment. FIGS. 4A to 4D are a view enlarging time t1 to t5 of FIG. 3. FIG. 4A shows field intensity that a mobile terminal receives. FIG. 4B shows a control slot data outputted from the first and the second base stations, CS1 and CS2. FIG. 4C is an electric field existence signal EF outputted from the RSSI evaluation unit 3 of this embodiment. FIG. 4D is a view showing an operating state of an internal circuit of the mobile terminal of this embodiment.

Firstly, at a point prior to a time t1, a mobile terminal start selecting a base station. At this time, for example a default threshold (initial value) is set to the threshold value storing unit 36. The initial value is lowest level field intensity consider to be possible to communicate between a base station and a mobile terminal (see FIG. 4A).

At the time t1 shown in FIGS. 4A to 4D, if a mobile terminal receives a control slot transmitted from the first base station CS1, field intensity of the signal being received becomes stronger (see FIG. 4A). If the field intensity becomes stronger than the threshold retained in the threshold storing unit 36, the RSSI comparator 33 outputs an electric field existence signal EF indicating “electric field exists” (H level signal in FIG. 4C). In response to the signal indicating “electric field exists”, the demodulation circuit 4 starts demodulation operation. A circuit for receiving the demodulated signal and processing the demodulated signal starts an operation as well (see FIG. 4D).

After starting to receive the control slot, the control unit 351 performs a following control to the adder 353 and the threshold storing unit 36 at any timing (for example a timing when a certain time has passed after starting the reception operation).

1) Retrieving a digital value (RSSI value) indicating field intensity after start the reception operation and adding an addition value in the addition value storing unit 352 retained by the adder 353 to the RSSI value.

2) Storing the obtained value (RSSI value+addition value) to the threshold storing unit 36 as a new threshold (dotted line in FIG. 4A indicates a change in threshold).

With the operation described above, a new threshold is stored to the threshold storing unit 36 and an analog value outputted from the D/A converter 37 becomes larger than an analog value indicating field intensity. The RSSI comparator 33 therefore outputs an electric field existence signal EF indicating “electric field does not exist” at a time t2 (see FIG. 4C).

At this time, once a signal indicating “electric field exists” is inputted, the demodulation circuit of this embodiment and a subsequent circuit for processing demodulated data continue to demodulate and process data as long as there is no reset operation, which is described later, until an end position of a control slot is detected. This operation ensures that a mobile terminal receives a control slot outputted from the CS1 correctly to its end point.

On the other hand, if a control slot is transmitted from the second base station while receiving a control slot from the first base station CS1, field intensity of the second base station CS2 is detected to be larger than field intensity of a radio wave received from the first base station because the second base station CS2 is closer to the mobile terminal than the first base station (see time t3 in FIG. 4A). At a time t3 shown in FIGS. 4A to 4D, a threshold retained by the threshold storing unit 36 is (RSSI value+addition value) (see dotted line in FIG. 4A). The RSSI comparator 33 outputs a result of a comparison between the newly specified threshold and the field intensity for the received radio wave.

If a mobile terminal receives a radio wave having field intensity stronger than the field intensity of radio wave received from the first base station, the RSSI comparator 33 again outputs an electric field existence signal EF indicating “electric field exists”. In this manner, if the mobile terminal receives a signal with field intensity that exceeds a newly specified threshold while receiving a control slot, the demodulation circuit of this embodiment as well as a circuit for processing demodulated data perform a reset operation in response to a rising edge of the signal indicating “electric field exists”. Then the mobile terminal starts a reception operation for a signal received with new field intensity. After that a new threshold is specified according to a RSSI value received again and retained in the threshold value storing unit 36. This operation is repeated and a base station is selected when there is no duplication in control slots and all slot data are received. Then the mobile terminal returns the threshold to an initial value and enters into a standby mode until receiving a control slot next time.

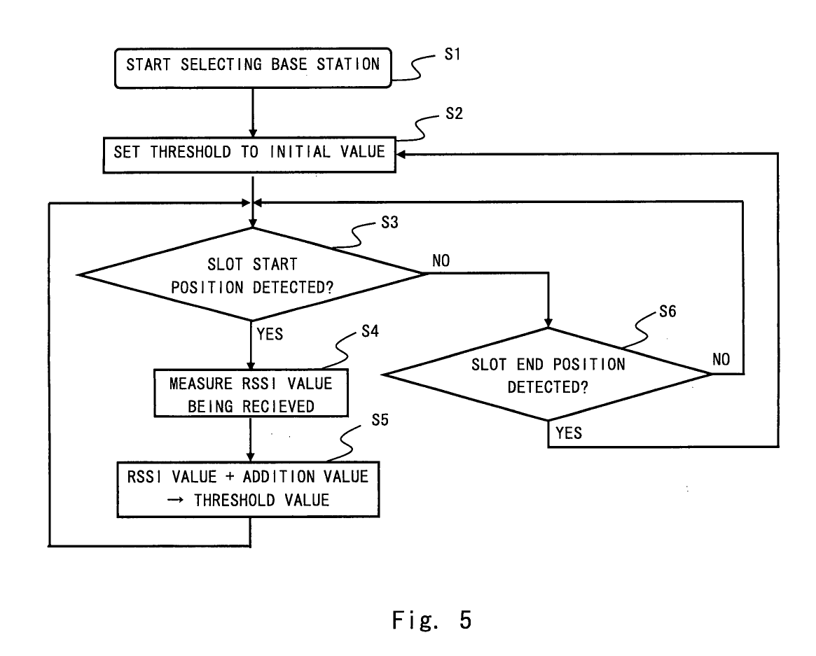

A control flow of the above operation is shown in FIG. 5. In FIG. 5, explanations for operations identical to the explanations above are simplified. Firstly in step S1 in FIG. 5, a mobile terminal PS starts selecting a base station.

In step S2, an initial value of threshold is specified. Although the initial value specified here varies depending on a circuit configuration of a mobile terminal and surrounding circumstances, a lowest level possible to communicate between a mobile terminal and a base station is specified as a threshold.

In step S3, an electric field existence signal EF shown in FIG. 4C is monitored to evaluate whether a control slot is started. If it is evaluated that a control slot has started (if the electric field existence signal EF transits from a signal indicating “electric field does not exist” to a signal indicating “electric field exists”), the mobile terminal PS performs a reset operation to the demodulation circuit 4 etc and moves onto step S4. In a case it is not evaluated that control slot has started, the process moves onto a step S6.

At the step S4, a RSSI value of a reception signal is measured at a specified timing after start receiving a control slot. The RSSI value is measured by inputting an output from the A/D converter 32 to the adder 353 at a specified timing or by reading the RSSI value retained in the RSSI conversion result storing unit 34. After measuring a RSSI value, the process moves onto step S5.

At the step S5, the above-mentioned adder 353 adds a specified addition value to the measured RSSI value and stores the added value to the threshold storing unit 36 as a new threshold. Accordingly the electric field existence signal EF transits to a signal indicating “electric field does not exist”. Then the process goes back to the step S3 to monitor the electric field existence signal EF. If a mobile terminal receives a control slot having stronger field intensity than field intensity of a control slot that the mobile terminal is already receiving, the electric field existence EF again transits from “electric field exists” to “electric field does not exists” according to the new threshold, thereby repeating the steps S4 and S5.

If start of a control slot is not detected at the step S3, it is evaluated whether an end position of a control slot is detected at the step S6. The evaluation is performed according to the number of bits in data from a start of reception. If an end position of a control slot is detected here, it indicates that the process has already passed through steps S3 to S5 and successfully received a control slot that has been started to receive, thus the process goes back to the step S2 and returns a threshold to an initial value. If end position of data is not detected, the process goes back to the step S3 and continues to monitor an electric field existence signal EF.

As described in the foregoing, this embodiment enables to detect a start of a control slot that a mobile terminal receives and to increase a threshold according to a field intensity of the control slot that the mobile terminal has started to receive. By controlling as above, even in a case a control slot is received from a closer base station while still receiving another control slot, the mobile terminal is capable of recognizing a change in base stations that transmit control slots by a change in the field intensity. If a base station is changed, the mobile terminal is able to receive a control slot from the closer base station by resetting a reception operation for the currently receiving control slot. Further, as patterns for control slot data are predetermined, as long as there is no reset operation while receiving a control slot, the mobile terminal is able to definitely receive the control slot by detecting its end position. Even in a case a control slot having a lower field intensity than a threshold newly specified during a reception operation of a control slot, a reset operation is not performed according to the control slot having a lower field intensity because the threshold is determined based on field intensity of the control slot being received.

With the first embodiment of the present invention as described so far, a mobile terminal is able to select a base station with highest field intensity for communication without having a reception error when selecting a base station. Accordingly without repeating a selection of a base station for several times due to a reception error as with a conventional technique, time taken for selecting a base station can be reduced. Further, with a conventional technique, although there have been cases that a base station far away is selected to transmit a request for establishing a link thereto as a result of a reception error, a selection of such a base station can be reduced with this embodiment of the present invention.

### Second Embodiment

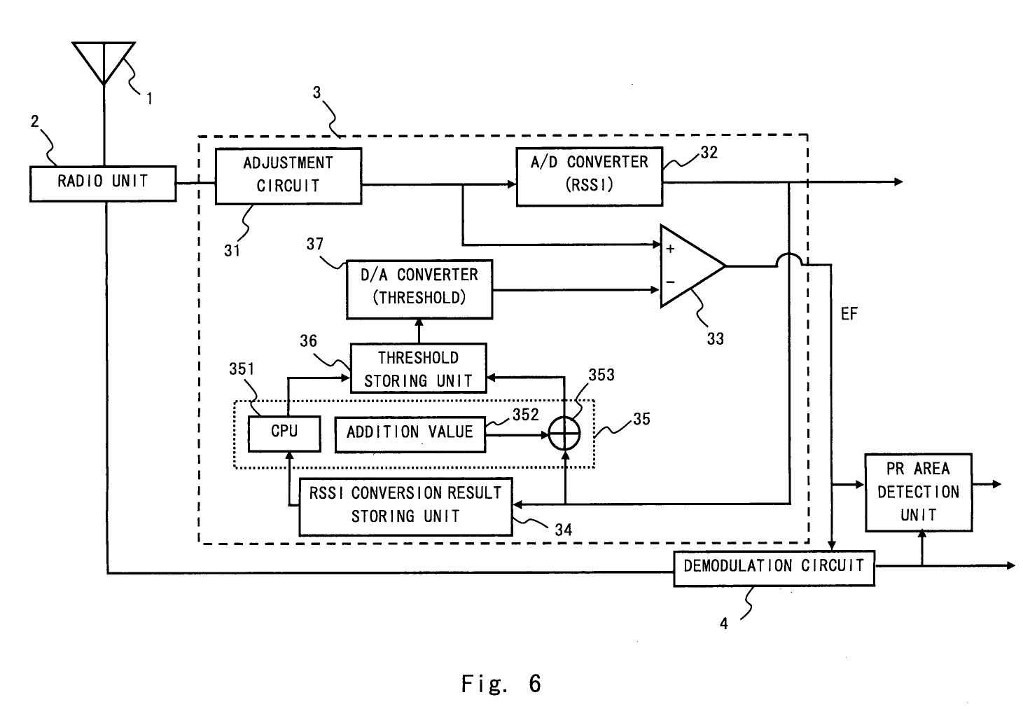

FIG. 6 is a view showing a configuration of a mobile terminal of a second embodiment of the present invention. In FIG. 2, constituents identical to those in the first embodiments are denoted by reference numerals identical to those therein with detailed description omitted. A PR area detection unit 5 is added to the mobile terminal shown in FIG. 6.

In the same way as the demodulation circuit, the PR area detection unit 5 launches followed by a transition of the electric existence signal EF from “electric field exists” to “electric field does not exist” and detects a particular pattern in data demodulated by the demodulation circuit.

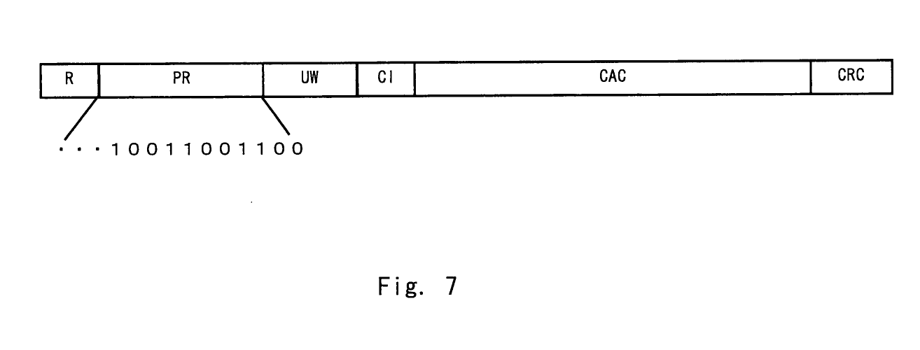

FIG. 7 is a view showing a data configuration of a control slot with an example of PHS system. As shown in FIG. 7, a control slot is comprised of lamp bits R, preamble bits PR, unique words UW, control data CAC, and CRC (Cyclic Redundancy Check) bits and the like.

The preamble bits PR are not specific data such as data relating to information of a base station, but in compliance with a standard, it is an area where a fixed pattern “1001” is continuously repeated. Accordingly necessary information to process demodulated data is appended to the PR area. In the second embodiment, field intensity becomes stronger and the PR area detection unit 5 detects a pattern in data that is modulated by the demodulated circuit 4. If the PR area detection unit 5 detects a pattern of a PR area as a result, a process of data received by a subsequent circuit is started.

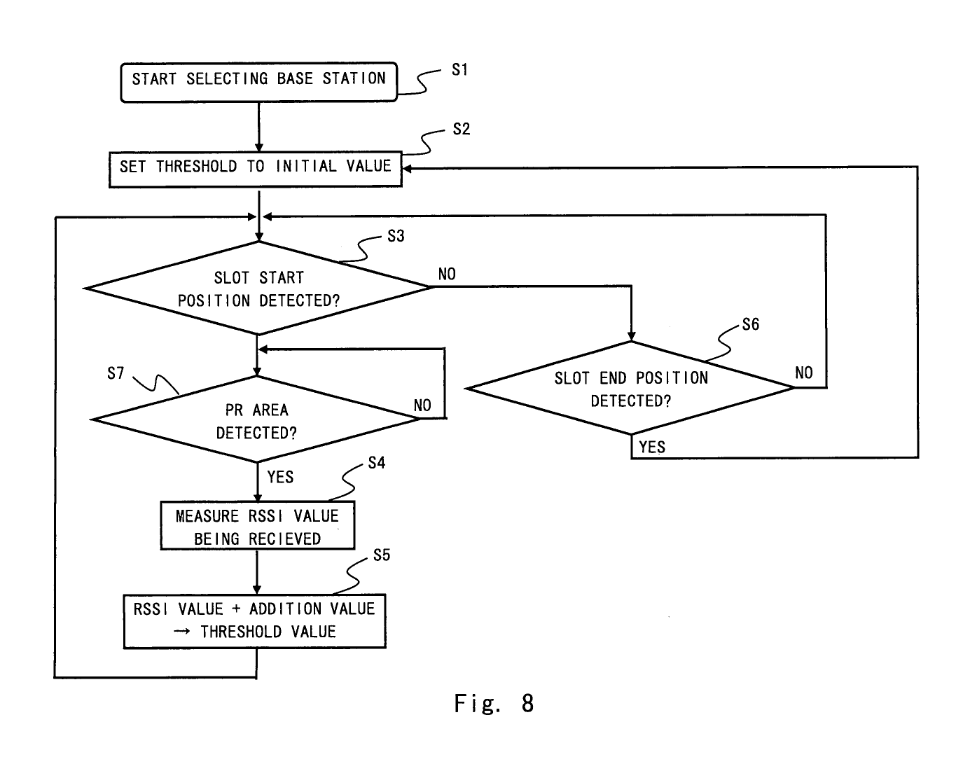

An operation flow of the second embodiment is shown in FIG. 8. In FIG. 8, operations identical to those in the first embodiment are denoted by reference numerals identical to those therein with detailed description omitted. In a mobile terminal of the second embodiment, an operation of S7 is added as in FIG. 8. Specifically, in step S3, if field intensity exceeds a threshold and a start position of a slot is detected, the PR area detection unit 5 monitors a pattern of demodulated data. If a PR area is detected as a result, it is evaluated to be a control slot and the process moves to step S4. If a PR area is not detected, it is evaluated that receiving data is not a control slot, and a monitor on demodulated data is continued.

As described so far in the second embodiment, if a pattern is detected in demodulated data and evaluated to be a control slot, the control slot is received to start processing data and accuracy in starting the process can be improved. Further, incorrect recognition and reception error can further be reduced as a pattern in demodulated data can be detected if received field intensity exceeds a threshold.

Preferred embodiments of the present invention is described in detail in the foregoing, the present invention allows to correctly receive a control slot even in a case control slot transmitted by a base station is not synchronized, without a reception error in a mobile terminal. Consequently when the mobile terminal selects a base station, the mobile terminal is able to preferentially select a base station that is stable and communicable.

It is apparent that the present invention is not limited to the above embodiment and it may be modified and changed without departing from the scope and spirit of the invention.

What is claimed is:

1. A mobile terminal device comprising:
a threshold storing unit for retaining a threshold of field intensity;
a comparator for comparing field intensity of a signal received from a base station with the threshold and outputting an electric field existence signal;
a demodulation circuit for starting a reception operation according to a specified transition of the electric field existence signal; and
a threshold setting unit for changing a threshold retained by the threshold storing unit according to a specified transition of the electric field existence signal.

2. The mobile terminal device according to claim 1, wherein the threshold setting unit changes the threshold according to field intensity of a signal received from the base station.

3. The mobile terminal device according to claim 1, wherein the threshold setting unit changes the threshold so that the threshold is larger than field intensity of a signal received from the base station.

4. The mobile terminal device according to claim 2, wherein the threshold setting unit changes the threshold so that the threshold is larger than a value based on field intensity of a signal received from the base station.

5. The mobile terminal device according to claim 1, wherein the threshold setting unit comprises an adder and the adder changes the threshold by adding a specified value to a field intensity value obtained from field intensity of a signal received from the base station, according to a specified transition of the electric field existence signal.

6. The mobile terminal device according to claim 1, further comprising an area detection circuit for monitoring data demodulated by the demodulation circuit and outputting a signal to start data process if the monitoring data is in a specified pattern data.

7. A motion control method for a mobile terminal device comprising:
comparing field intensity of a signal received from a base station with a threshold;
starting a reception operation according to a result of the comparison; and
changing the threshold according to field intensity of a signal received from the base station during the reception operation.

8. The motion control method for a mobile terminal device according to claim 7, wherein the change of the threshold is performed so that the threshold is larger than field intensity of a signal received from the base station during the reception operation.

9. The motion control method for a mobile terminal device according to claim 7, wherein the change of the threshold is performed so that the threshold is larger than a value based on field intensity of a signal received from the base station during the reception operation.
